(19) United States
(12) Patent Application Publication
(10) Pub. No.: US 2008/0116757 A1
(43) Pub. Date: May 22, 2008

(54) MOTOR HAVING MAGNETIC FLUID BEARING STRUCTURE

(76) Inventors: Sean CHANG, Taoyuan Hsien (TW); Chii-How CHANG, Taoyuan Hsien (TW); Chin-Chun LAI, Taoyuan Hsien (TW); Li-Ming CHEN, Taoyuan Hsien (TW); Ching-Hsiang YU, Taoyuan Hsien (TW); Chia-Chi WU, Taoyuan Hsien (TW)

Correspondence Address: BIRCH STEWART KOLASCH & BIRCH, PO BOX 747, FALLS CHURCH, VA, 22040-0747, US

(21) Appl. No.: 11/940,105

(22) Filed: Nov. 14, 2007

(30) Foreign Application Priority Data
Nov. 17, 2006 (TW) 095142581
Nov. 17, 2006 (TW) 095142582
Nov. 17, 2006 (TW) 095142583
May 31, 2007 (TW) 096119480

(51) Int. Cl. H02K 7/09; F16C 33/10; H02K 5/128

(52) U.S. Cl. 310/90.5; 384/133; 310/89

(57) ABSTRACT

A motor having a magnetic fluid bearing structure, which includes at least one bearing, at least one magnetic element and a magnetic fluid. The bearing is telescoped onto a shaft, and the magnetic element is coupled to the bearing. The magnetic fluid is kept between the bearing and the shaft. According to a magnetic effect between the magnetic fluid and the magnetic element, it is possible to prevent a lubricant of the bearing from leaking, and a hydraulic pressure of the magnetic fluid provides additional axial and radial supports to make the shaft rotate steadily relative to the bearing.

### CROSS REFERENCE TO RELATED APPLICATIONS

This Non-provisional application claims priority under 35 U.S.C. §119(a) on Patent Application No(s). 095142581, 095142582 and 095142583 filed in Taiwan, Republic of China on Nov. 17, 2006, and the Patent Application No 096119480 filed in Taiwan, Republic of China on May 31, 2007, the entire contents of which are hereby incorporated by reference.

### BACKGROUND OF THE INVENTION

1. Field of Invention

The invention relates to a motor and, in particular, to a motor having a magnetic fluid bearing structure.

2. Related Art

In response to the smoothness and the stability of the motor at a high rotating speed, a bearing is conventionally used to support a shaft. Referring to FIG. 1, a conventional motor 1 includes a stator 11, a shaft 12, a bearing 13 and an oil seal 14. The bearing 13 is a sleeve bearing, and the oil seal 14 can be a loop or a metal ring. The oil seal 14 is disposed above the bearing 13 and is mounted around the shaft 12, and seals the lubricant in the bearing 13. When the motor 1 is rotating, the bearing 13 provides the lubrication for the shaft 12 according to the viscosity of the lubricant so that the shaft 12 can rotate smoothly.

However, the oil seal 14 is mounted around the shaft 12 and the space for storing the lubricant cannot be completely sealed. Thus, the lubricant tends to leak slowly after the motor 1 has rotated at the high speed for a long period of time. Therefore, the lubrication between the shaft 12 and the bearing 13 is reduced, and the reliability and the lifetime of the motor 1 tend to deteriorate.

Therefore, it is an important subject to keep a lubricant in the bearing effectively so as to reduce the consumption of the lubricant, thereby enhancing the reliability and the lifetime of the motor.

### SUMMARY OF THE INVENTION

In view of the foregoing, the invention is to provide a motor having a magnetic fluid bearing structure, in which a lubricant is kept in a bearing effectively according to a generated magnetic field so that the consumption of the lubricant can be reduced. Furthermore, the magnetic field can make the magnetic fluid generate additional axial and radial supporting forces so that the reliability and the lifetime of the motor can be enhanced.

To achieve the above, the invention discloses a magnetic fluid bearing structure, which includes at least one bearing, at least one magnetic element and magnetic fluid. The bearing is telescoped onto a shaft, and the magnetic element is disposed adjacent to the bearing. The magnetic fluid is kept between the bearing and the shaft. According to a magnetic effect between the magnetic fluid and the magnetic element, it is possible to prevent a lubricant of the bearing from leaking, and a hydraulic pressure of the magnetic fluid provides additional axial and radial supports to make the shaft rotate steadily relative to the bearing.

To achieve the above, a motor according to the invention includes a rotor, a stator and a magnetic fluid bearing structure. The rotor has a shaft. The stator is disposed corresponding to the rotor. The magnetic fluid bearing structure includes a bearing, at least one magnetic element and magnetic fluid. The bearing is telescoped onto the shaft, the magnetic element is disposed adjacent to the bearing, and the magnetic fluid is kept between the bearing and the shaft. According a magnetic effect between the magnetic fluid and the magnetic element, it is possible to prevent a lubricant of the bearing from leaking, and a hydraulic pressure of the magnetic fluid provides additional axial and radial supports to make the shaft rotate steadily relative to the bearing.

In addition, the invention also discloses a motor including a sleeve, a rotor, a bearing, a stator and a magnetic oil seal structure. The rotor has a shaft. The bearing is telescoped onto the shaft and accommodated in the sleeve. The stator is disposed corresponding to the rotor and telescoped onto the sleeve. The magnetic oil seal structure is telescoped onto the shaft, seals an end portion of the sleeve, and includes magnetic fluid, at least one magnetic element and at least one magnetic-conducting element. The magnetic fluid is kept between the sleeve and the shaft. The magnetic-conducting element is combined with the magnetic element. The magnetic oil seal structure is formed according to magnetic effects between the magnetic fluid, the magnetic-conducting element and the magnetic element.

In addition, the invention further discloses a magnetic oil seal structure, which is telescoped onto a shaft and closes an end portion of a sleeve. The magnetic oil seal structure includes magnetic fluid, at least one magnetic element and at least one magnetic-conducting element. The magnetic fluid is kept between the sleeve and the shaft. The magnetic element is disposed on an end portion of the shaft. The magnetic-conducting element is disposed adjacent to the end portion of the sleeve. The magnetic element and the magnetic-conducting element form a magnetic loop. The magnetic oil seal structure is formed according to magnetic effects between the magnetic fluid, the magnetic element and the magnetic-conducting element.

As mentioned above, the motor having the magnetic fluid bearing structure according to the invention prevents the lubricant of the bearing from leaking according to the magnetic fluid accommodated between the bearing and the shaft and the magnetic effect between the magnetic element and the magnetic fluid. In addition, the generated hydraulic pressure provides the additional axial and radial supports to make the shaft rotate steadily relative to the bearing. Compared with the related art, the magnetic fluid of the invention generates the additional axial and radial supporting hydraulic pressures, which can provide the supporting forces when the shaft is either rotating or kept stationary, according to the magnetic field generated by the magnetic loop. In addition, the invention can enhance the rotating stability of the shaft, and can further keep the lubricant in the bearing effectively according to the magnetic attracting function of the magnetic element. Thus, the lubricant consumption can be decreased, and the reliability and the lifetime of the motor can be enhanced.

### BRIEF DESCRIPTION OF THE DRAWINGS

The present invention will become more fully understood from the subsequent detailed description and the accompanying drawings, which are given by way of illustration only, and thus are not limitative of the present invention, and wherein:

FIG. 1 is a schematic illustration showing a conventional motor;

FIG. 2 is a schematic illustration showing a motor and a magnetic fluid bearing structure thereof according to a first embodiment of the invention;

FIG. 3 is a schematic illustration showing a motor and a magnetic fluid bearing structure thereof according to a second embodiment of the invention;

FIG. 4 is a schematic illustration showing a motor and a magnetic fluid bearing structure thereof according to a third embodiment of the invention;

FIG. 5 is a schematic illustration showing a motor and a magnetic fluid bearing structure thereof according to a fourth embodiment of the invention;

FIG. 6 is a schematic illustration showing a motor and a magnetic fluid bearing structure thereof according to a fifth embodiment of the invention;

FIG. 7 is a schematic illustration showing a motor and a magnetic fluid bearing structure thereof according to a sixth embodiment of the invention;

FIG. 8 is a schematic illustration showing a motor and a magnetic fluid bearing structure thereof according to a seventh embodiment of the invention;

FIG. 9A is a schematic illustration showing a combination of one magnetic element and two magnetic-conducting elements according to the seventh embodiment of the invention;

FIG. 9B is a schematic illustration showing another magnetic element according to the seventh embodiment of the invention;

FIG. 10 is a schematic illustration showing a motor and a magnetic fluid bearing structure thereof according to an eighth embodiment of the invention;

FIG. 11 is a schematic illustration showing a motor and a magnetic fluid bearing structure thereof according to a ninth embodiment of the invention;

FIG. 12 is a schematic illustration showing a motor and a magnetic fluid bearing structure thereof according to a tenth embodiment of the invention; and

FIG. 13 is a schematic illustration showing a motor and a magnetic fluid bearing structure thereof according to an eleventh embodiment of the invention.

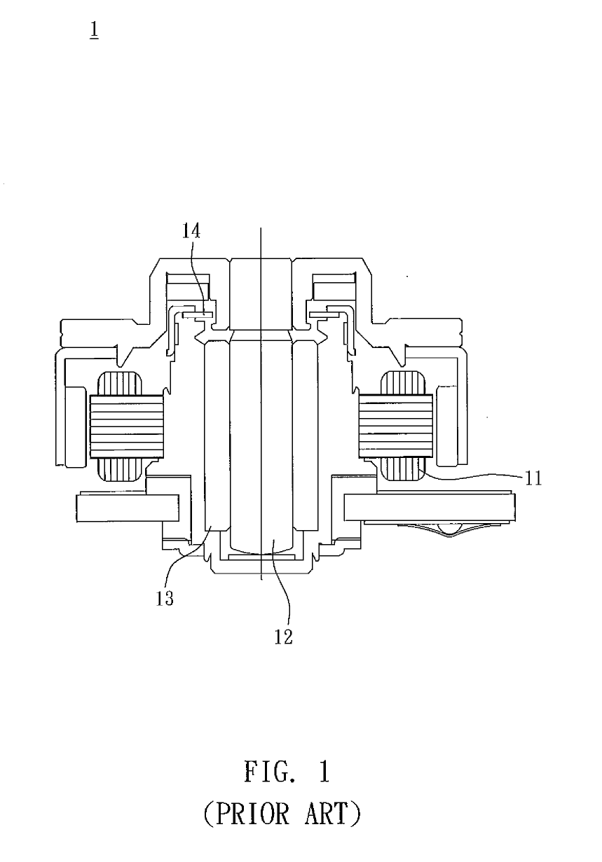

### DETAILED DESCRIPTION OF THE INVENTION

The present invention will be apparent from the following detailed description, which proceeds with reference to the accompanying drawings, wherein the same references relate to the same elements.

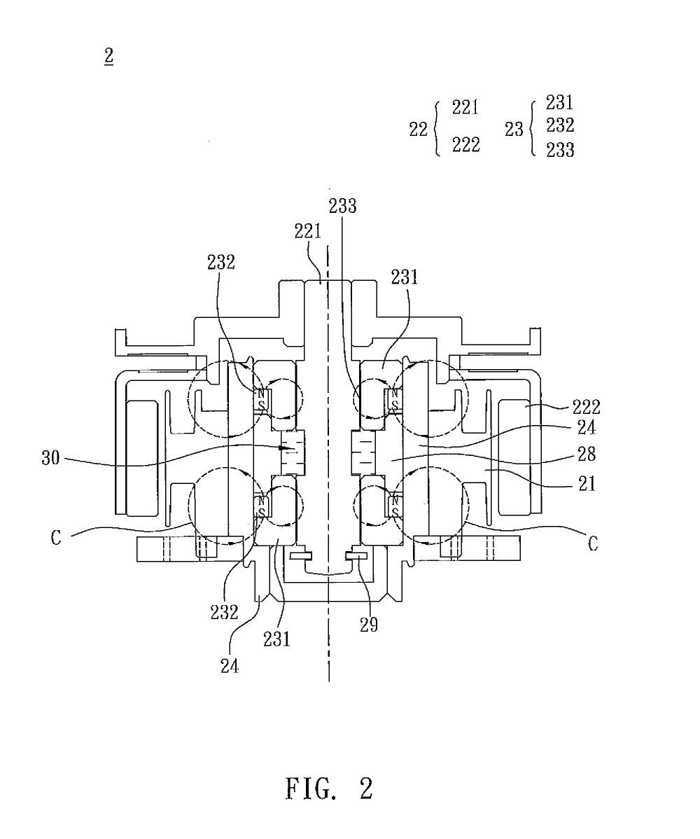

As shown in FIG. 2, a motor 2 according to a first embodiment of the invention includes a rotor 22, a stator 21 and a magnetic fluid bearing structure 23. The rotor 22 has a shaft 221 and a magnet 222. In this embodiment, the shaft 221 does not have the magnetic-conducting property. The stator 21 is disposed corresponding to the rotor 22, and between the magnet 222 and the shaft 221. The magnetic fluid bearing structure 23 includes at least one bearing 231, at least one magnetic element 232 and magnetic fluid 233. In this embodiment, the magnetic fluid bearing structure 23 has two bearings 231 and two magnetic elements 232. Each of the magnetic elements 232 can be, without limitation to, a permanent magnet, an electronic magnet or a magnet. The magnetic fluid 233 can contain iron, cobalt, nickel or alloys thereof.

The motor 2 further includes a first positioning element 28 and a second positioning element 29. The first positioning element 28 has the magnetic-conducting property or does not have the magnetic-conducting property. The second positioning element 29 is a ring, magnetic-pressure magnet or wear-resistant sheet. In this embodiment, the magnetic fluid bearing structure 23 is accommodated in a sleeve 24 of the motor 2. The sleeve 24 can be a hollow cylinder with a closed end or a hollow cylinder having an end closed by a cover. The bearings 231 are telescoped onto the shaft 221 and disposed against the first positioning element 28 to form a chamber 30 for accommodating the lubricant of the bearings 231. The magnetic elements 232 are disposed adjacent to the outer ring of the bearing 231 and against the sleeve 24. One end of the shaft 221 is fit with the bottom of the sleeve 24 through the second positioning element 29. In addition, the sleeve 24 can make each element accommodated therein align with the same center. The magnetic fluid 233 is kept between the bearings 231 and the shaft 221 in the sleeve 24.

The magnetic fluid bearing structure 23 provides the lubrication and the protection for the motor 2 according to the following principle and procedures. When the motor 2 is not rotated, a magnetic loop C formed by the magnetic element 232 is distributed axially with respect to the shaft 221 and the bearings 231 also provide supports to the shaft 221 because the N and S poles of the magnetic element 232 are disposed axially. When the motor 2 is rotating, the magnetic loops C formed by the magnetic elements 232 can attract the magnetic fluid 233 through the bearings 231 and can be axially distributed between the bearings 231 and the shaft 221 because each of the bearings 231 has the magnetic-conducting property. The hydraulic pressure of the magnetic fluid 233 is increased with the increase of the magnetic flux density so that the better lubrication and supporting effects can be provided for the bearings 231 and the shaft 221, and the wear of each of the shaft 221 and the bearings 231 can be reduced. In addition, the magnetic attracting function provided by the magnetic elements 232 can be equivalent to an oil seal structure with respect to the magnetic fluid bearing structure 23 so that the lubricant consumption can be avoided.

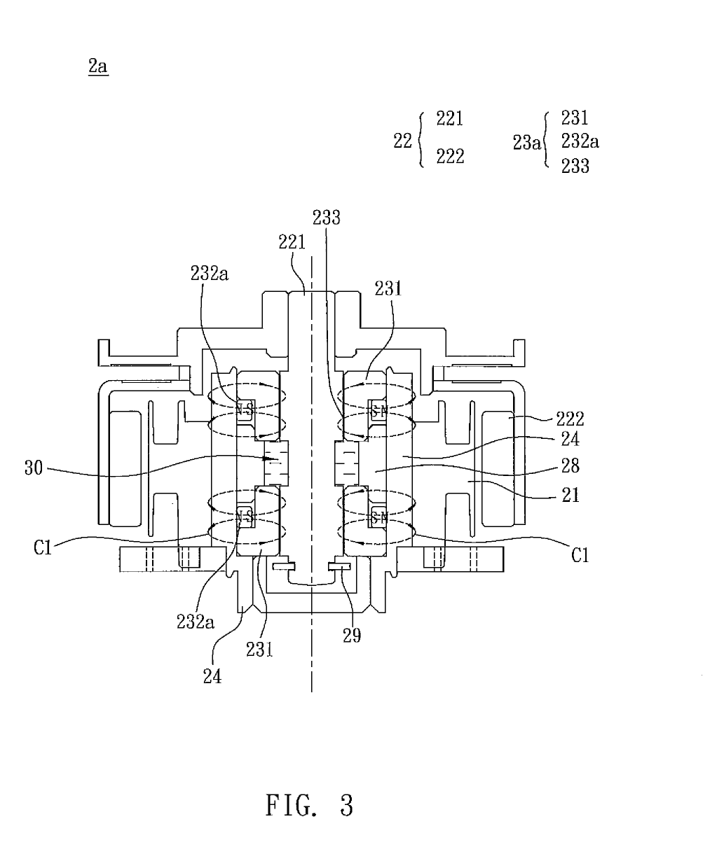

As shown in FIG. 3, the structure and the function of a motor 2a according to a second embodiment of the invention are the same as those of the motor 2 except that the N and S poles of each magnetic element 232a are arranged radially with respect to the shaft 221. Therefore, a magnetic loop C1 thereof is distributed radially with respect to the shaft 221. Because each of the bearings 231 has the magnetic-conducting property, the magnetic loops C1 formed by the magnetic elements 232a can attract the magnetic fluid 233 through the bearings 231 when the motor 2a is rotating. In addition, the magnetic loops C1 are in direct proportion to the magnetic flux density to radially provide the lubrication and supporting functions between the bearings 231 and the shaft 221, thereby decreasing the wear of each of the shaft 221 and the bearings 231, and equivalent to the oil seal structure to avoid the lubricant consumption.

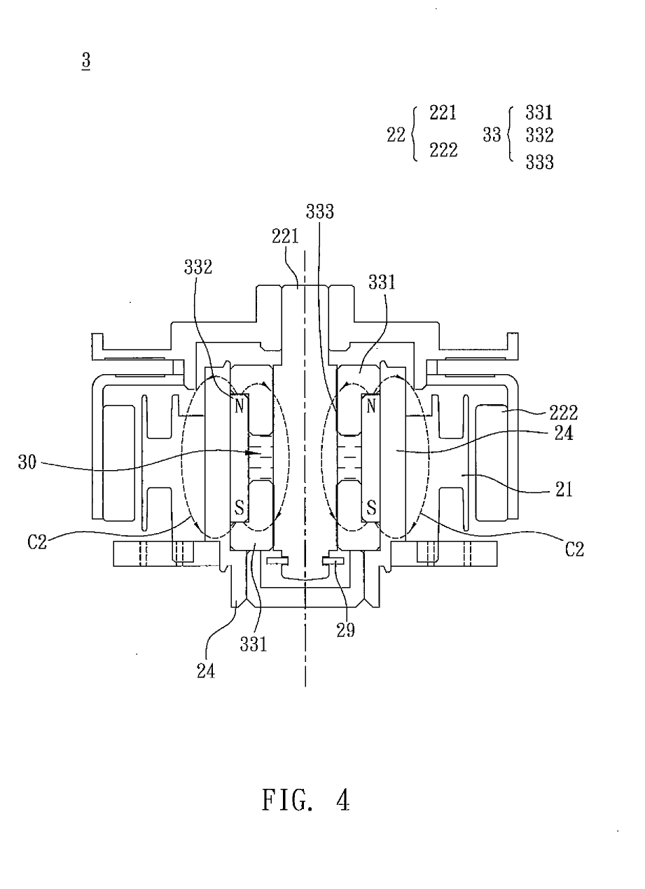

Referring to FIG. 4, a motor 3 according to a third embodiment of the invention are the same as those of the motor 2 of the first embodiment except that the shaft 221 has the magnetic-conducting property, and the magnetic fluid bearing structure 33 has two bearings 331, a magnetic element 332 and magnetic fluid 333. The magnetic element 332 is a permanent magnetic ring, which is an outer ring disposed adjacent to the bearings 331 and has the positioning function like the first positioning element 28. The magnetic fluid 333 is kept in the chamber 30 between the bearings 331 and the shaft 221 in the sleeve 24.

When the motor 3 is rotating, a magnetic loop C2 formed by the magnetic element 332 can attract the magnetic fluid 333 through the bearings 331 and the shaft 221 and is axially distributed between the bearings 331 and the shaft 221 because each of the bearings 331 and the shaft 221 has the magnetic-conducting property and the N and S poles of the magnetic element 332 are arranged axially. It is to be noted that the portions of the shaft 221 and the bearings 331, which are not telescoped, also attract the magnetic fluid 333 because the shaft 221 has the magnetic-conducting property. The hydraulic pressure of the magnetic fluid 333 is also increased with the increase of the magnetic flux density so that better lubrication and supporting effects can be obtained to avoid the lubricant consumption.

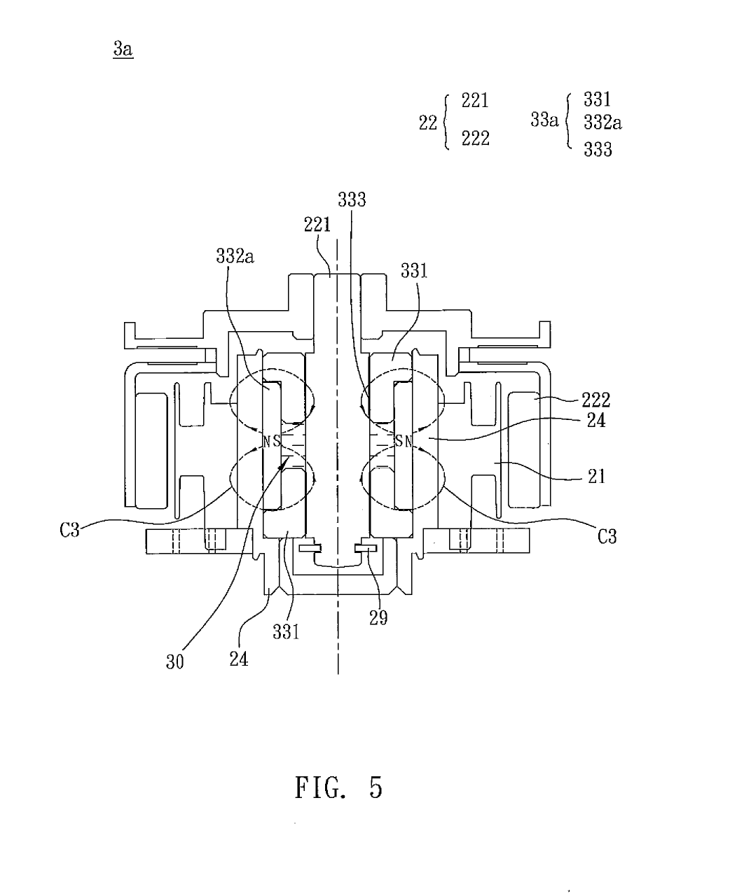

As shown in FIG. 5, the structure and the function of a motor 3a according to a fourth embodiment of the invention are the same as those of the motor 3 shown in FIG. 4 except that the N and S poles of a magnetic element 332a are arranged radially with respect to the shaft 221 in a magnetic fluid bearing structure 33a of this embodiment. Thus, a magnetic loop C3 is distributed radially with respect to the shaft 221. Because each of the bearings 331 and the shaft 221 has the magnetic-conducting property, the magnetic loop C3 formed by the magnetic element 332a can attract the magnetic fluid 333 to the contact surface between the shaft 221 and the bearings 331, and is in direct proportion to the magnetic flux density to radially provide the lubrication and supporting functions between the bearings 331 and the shaft 221. Thus, the wear of each of the shaft 221 and the bearings 331 can be decreased to avoid the lubricant consumption.

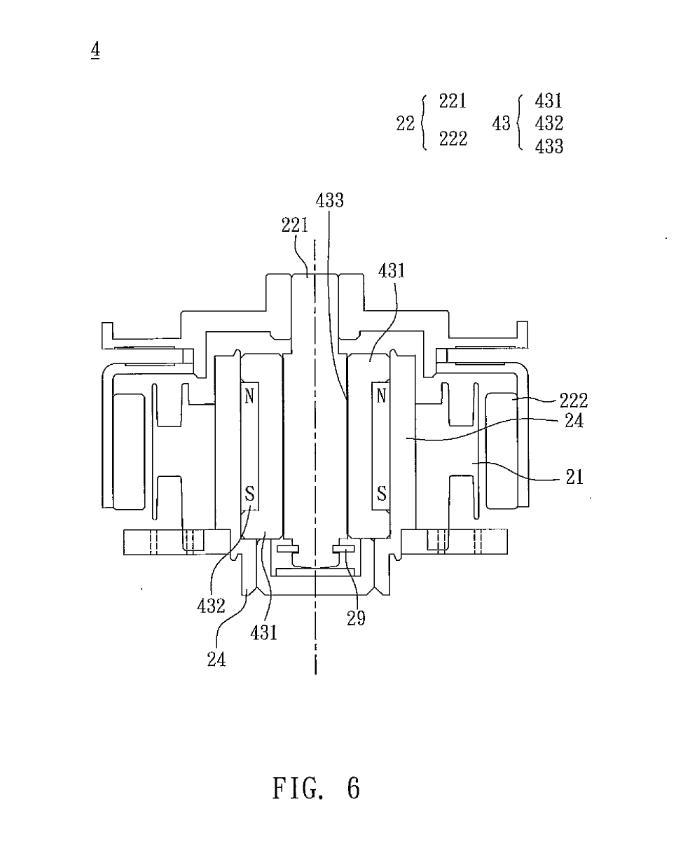

Referring to FIG. 6, a motor 4 according to a fifth embodiment of the invention are the same as those of the motor 3 shown in FIG. 4 except that the magnetic fluid bearing structure 43 is composed of a bearing 431 telescoped to a magnetic element 432. The magnetic element 432 is a permanent magnetic ring, and magnetic fluid 433 is kept between the bearing 431 and the shaft 221. This embodiment can be achieved without the first positioning element mentioned herein above. The oil sealing, lubrication and supporting functions of the magnetic fluid bearing structure 43 provided to the motor 4 are the same as those mentioned hereinabove, and detailed descriptions thereof is omitted.

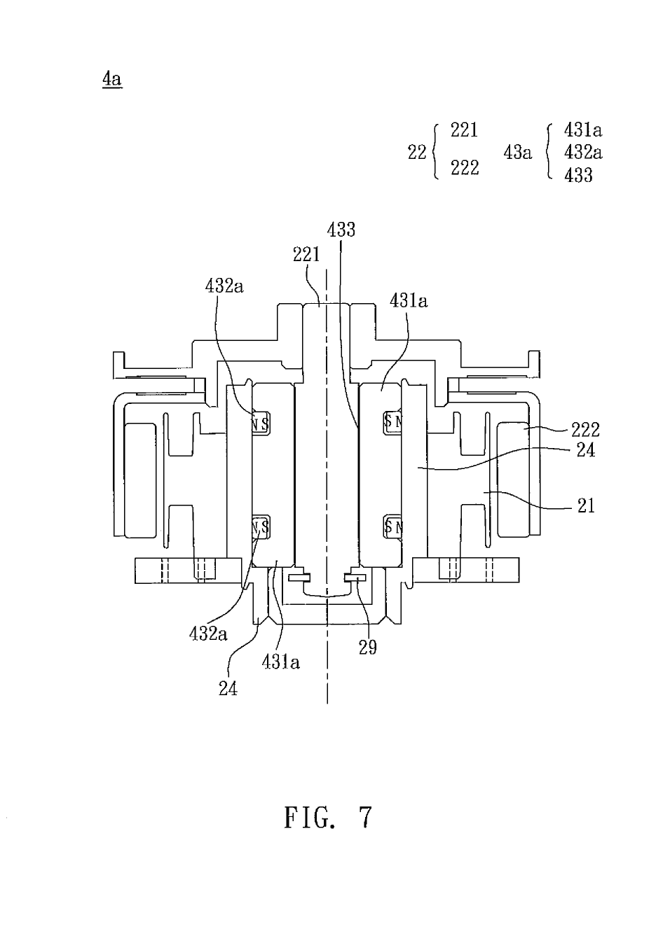

As shown in FIG. 7, the structure and the function of a motor 4a according to a sixth embodiment of the invention are the same as those of the motor 4 except that a magnetic fluid bearing structure 43a is composed of a bearing 431a telescoped to two magnetic elements 432a, each of which is a permanent magnetic ring.

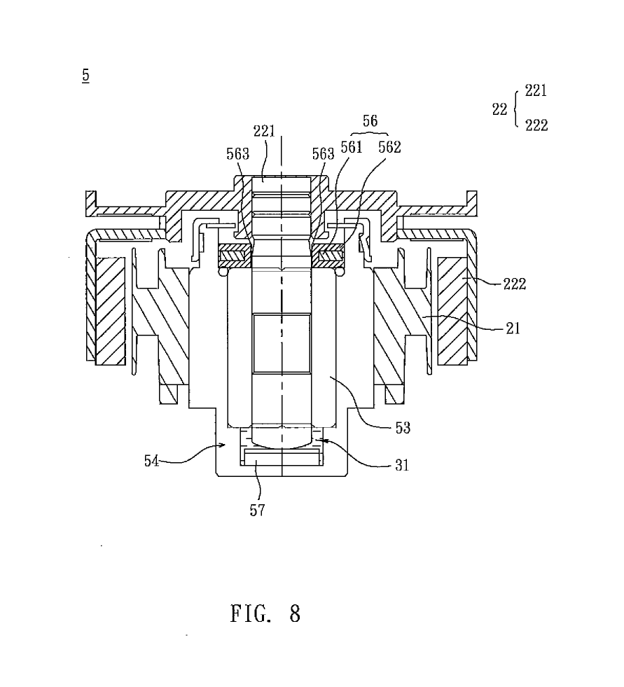

Referring to FIG. 8, a motor 5 according to a seventh embodiment of the invention includes a sleeve 54, a rotor 22, a bearing 53, a stator 21 and a magnetic oil seal structure 56. The rotor 22 has a shaft 221 and a magnet 222. The stator 21 is disposed between the magnet 222 and the shaft 221 corresponding to the rotor 22, and is fit within the sleeve 54. In this embodiment, the sleeve 54 can be a hollow cylinder with a closed end or a hollow cylinder having an end closed by a cover. The bearing 53 is telescoped onto the shaft 221 and is accommodated in the sleeve 54. One end portion of the shaft 221 is disposed against a third positioning element 57, which is a magnetic-pressure magnet or a wear-resistant sheet. Because the shaft 221 has the magnetic-conducting property, the third positioning element 57 can provide a stable supporting magnetic force to the shaft 221. A lubricant 31 is kept between the bearing 53 and the shaft 221 to provide the required lubrication.

The magnetic oil seal structure 56, disposed adjacent to the end portion of The bearing 53 and mounted around a shaft 221, includes at least one magnetic element 561, at least one magnetic-conducting element 562 and magnetic fluid 563. The magnetic element 561 is an electronic magnet, a magnet or a magnetite including, without limitation to, a neodymium-iron-boron magnetic element. The magnetic-conducting element 562 is a magnetic yoke including, without limitation to, a claw-pole magnetic yoke. The magnetic fluid 563 is kept between the magnetic-conducting element 562 and the shaft 221 and contains iron, cobalt, nickel or alloys thereof.

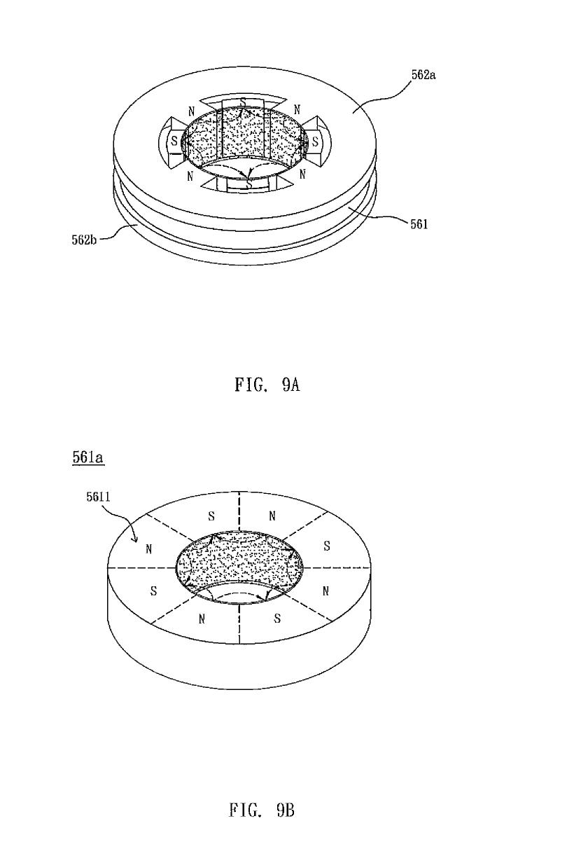

FIG. 9A is a schematic illustration showing a combination of one magnetic element and two magnetic-conducting elements of FIG. 8. In this embodiment, the magnetic element 561 is formed by axially magnetizing and sintering a neodymium-iron-boron magnet, and embedding magnetic-conducting elements 562a and 562b in the neodymium-iron-boron magnet. The magnetic-conducting element 562a is a claw-pole magnetic yoke having four N claw poles, and the magnetic-conducting element 562b is also a claw-pole magnetic yoke having four S claw poles. The magnetic-conducting elements 562a and 562b are combined together so that an eight-claw-pole magnetic yoke having the N and S poles arranged alternately is formed. In this embodiment, a six-claw-pole magnetic yoke having three N poles and three S poles arranged alternately can also be formed.

The magnetic effect of the magnetic oil seal structure 56 is that the magnetic element 561 conducts the magnetic property through the magnetic-conducting element 562. Because the N and S poles of the magnetic-conducting element 562 are arranged alternately, the lines of magnetic forces of the magnetic element 561 form a radial magnetic force loop distribution to attract the magnetic fluid 563. As shown in FIG. 8, when the motor 5 is rotating, the lubricant 31 gradually moves in a direction toward the magnetic oil seal structure 56 with the rotation of the shaft 221. At this time, the magnetic fluid 563 can stop the lubricant 31 from leaking outwards along the shaft 221 according to the magnetic effects between the magnetic fluid 563 and the magnetic element 561 and the magnetic-conducting element 562 (i.e., according to the condition that the radial magnetic loop distribution lightly attracts the magnetic fluid 563). Thus, the lubricant 31 can be kept in the bearing 53 after the motor 5 has rotated for a long period of time.

FIG. 9B is a schematic illustration showing another magnetic element according to this embodiment of the invention. As shown in FIG. 9B, the magnetic element 561a is a circular magnet formed by radially magnetizing a neodymium-iron-boron magnet. The circular magnet has magnetic-conducting regions 5611 in which four N and S poles are arranged alternately, and can also form a radial magnetic force loop distribution to attract the magnetic fluid 563.

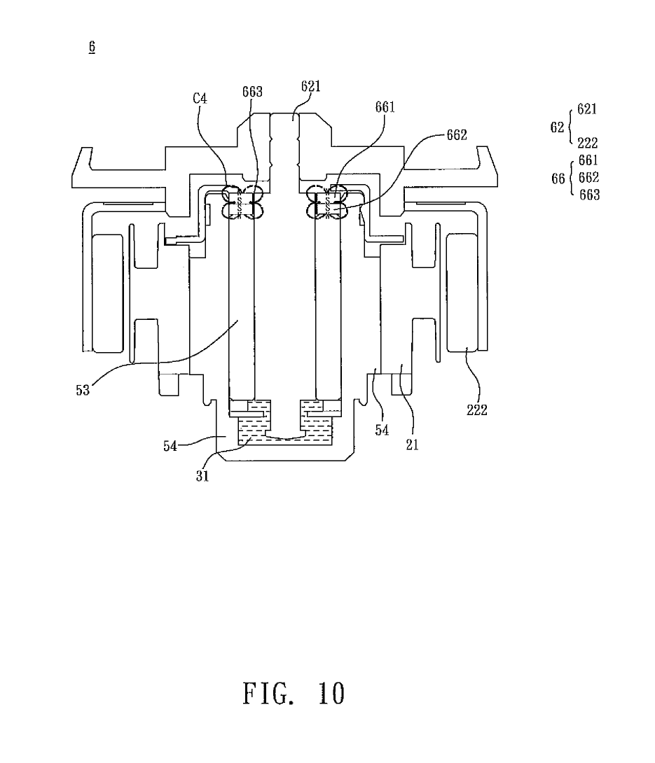

FIG. 10 shows a motor 6 according to an eighth embodiment of the invention. The motor 6 includes a sleeve 54, a rotor 62, a bearing 53, a stator 21 and a magnetic oil seal structure 66. The magnetic oil seal structure 66 includes at least one magnetic element and magnetic fluid 663. In this embodiment, the magnetic oil seal structure 66 includes two magnetic elements 661 and 662. The magnetic element is a magnet, a magnetite or an electronic magnet, and is disposed adjacent to the end portion of the bearing 53 and mounted around a shaft 621.

In this embodiment, the magnetic elements 661 and 662 are arranged repellently along the axial direction to form a magnetic loop C4 so that the lines of magnetic forces are collected to the middle between the magnetic elements 661 and 662 and the larger attracting force can be produced between the shaft 621 and the magnetic oil seal structure 66. It is to be noted that the magnetic oil seal structure 66 and the shaft 621 can form the magnetic loop C4, which is axially or radially distributed according to the arrangements of the magnetic elements 661 and 662.

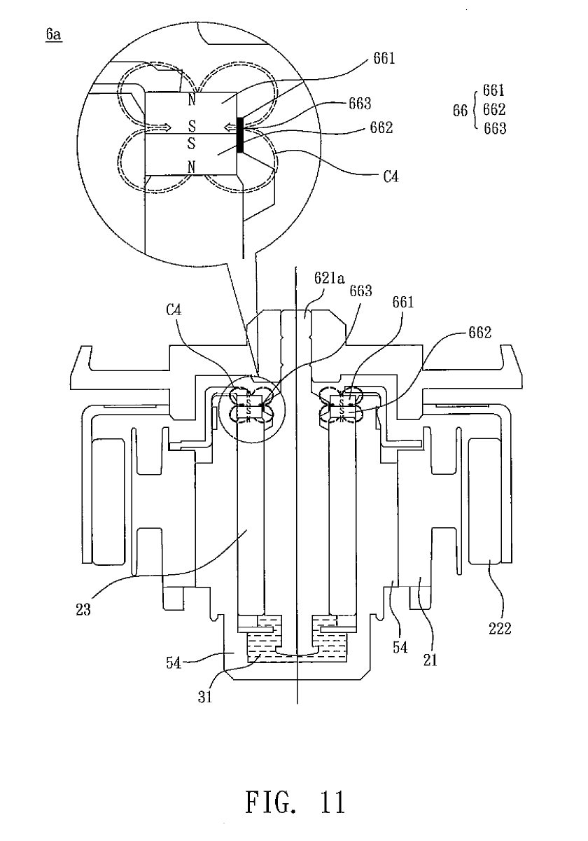

FIG. 11 shows a motor 6a according to a ninth embodiment of the invention. The structure and the function of the motor 6a are the same as those of the motor 6 except that a shaft 621a is formed with at least one slot or at least one projection so that the magnetic effect of the magnetic loop C4 formed between the shaft 621a and the magnetic elements 661 and 662 is converged and enhanced. Thus, a larger attracting force can be provided to the magnetic fluid 663 to prevent the lubricant 31 from leaking outwards along the shaft 621a. Thus, the lubricant 31 can be kept between the bearing 23 and the shaft 621a after the motor has rotated for a long period of time.

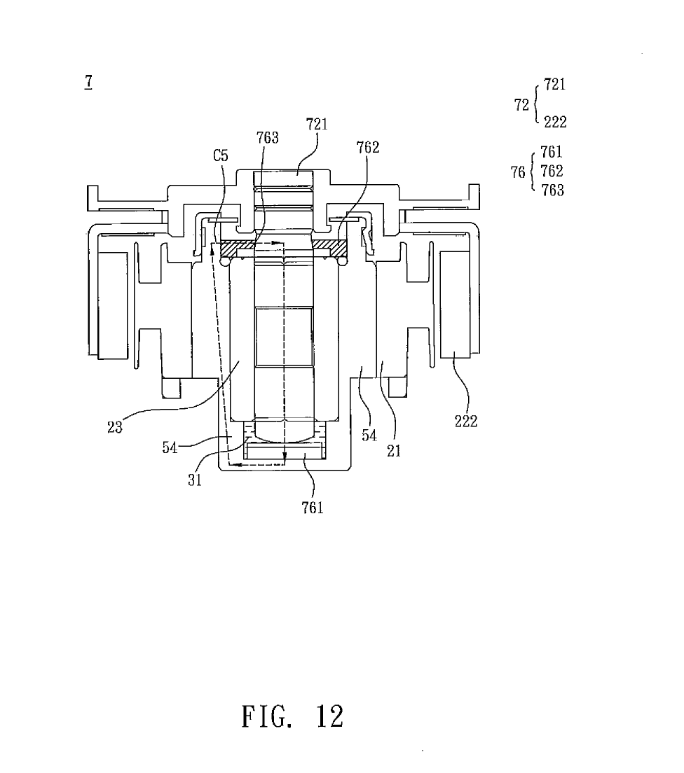

FIG. 12 shows a motor 7 according to a tenth embodiment of the invention. The motor 7 includes a sleeve 54, a rotor 72, a bearing 23, a stator 21 and a magnetic oil seal structure 76. The magnetic oil seal structure 76 includes at least one magnetic element 761, at least one magnetic-conducting element 762 and magnetic fluid 763. The rotor 72 has a shaft 721 and a magnet 222. The magnetic element 761 is the same as the third positioning element 57 of the motor 5 shown in FIG. 8 except the magnetic element has magnetic property. The stator 21 is disposed corresponding to the rotor 72. In detail, the stator 21 is disposed between the magnet 222 and the shaft 721 corresponding to the magnet 22 and is telescoped onto the sleeve 54. The bearing 23 is telescoped onto the shaft 721 and accommodated in the sleeve 54. The magnetic element 761 is disposed adjacent to an end portion of the shaft 721, and can be a magnet, a magnetite or an electronic magnet. In this embodiment, the magnetic element 761 is a magnetic-pressure magnet. The magnetic-conducting element 762, which may be a magnetic yoke, is disposed adjacent to the opening of the sleeve 54 to close the opening of the sleeve 54. The magnetic fluid 763 and a lubricant 31 are mixed together and kept between the sleeve 54 and the shaft 721. The magnetic fluid 763 contains iron, cobalt, nickel or alloys thereof. The lubricant 31 provides the lubrication between the bearing 23 and the shaft 721.

In this embodiment, the magnetic oil seal structure 76 prevents the lubricant 31 from leaking according to the following principle. When the motor 7 is not rotating, the magnetic element 761 can form a magnetic loop C5 by the magnetic element 761, the shaft 721 and the magnetic-conducting element 762 because the magnetic-conducting element 762 and the magnetic element 761 are respectively disposed adjacent to two ends of the shaft 721 and the shaft 721 has the magnetic-conducting property. The magnetic loop C5 is axially distributed with respect to the shaft 721 and the magnetic element 761 provides a magnetic pressure to the shaft 721.

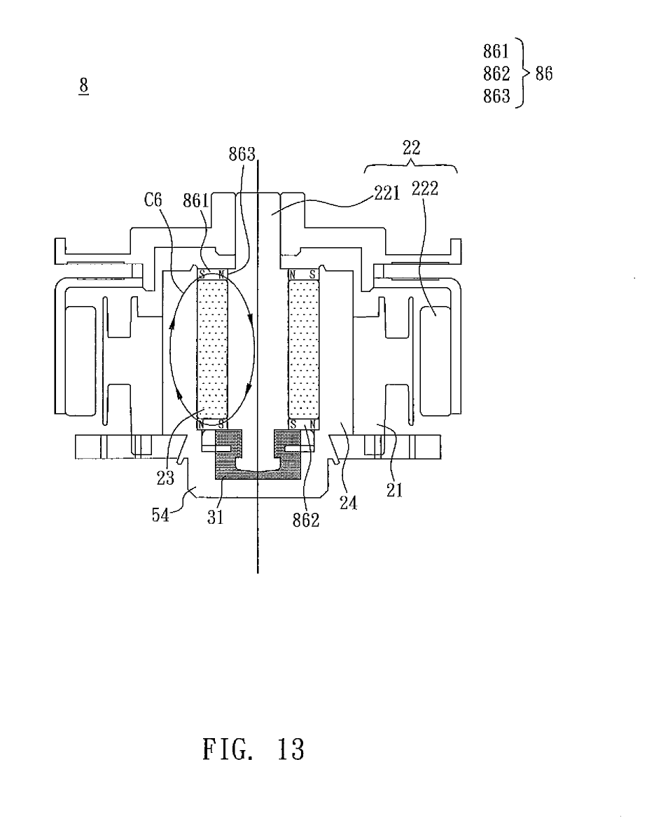

FIG. 13 shows a motor 8 according to an eleventh embodiment of the invention. The structure and the function of the motor 8 are almost the same as those of the motor 7 except that a magnetic oil seal structure 86 according to this embodiment includes a plurality of magnetic elements 861 and 862 and magnetic fluid 863. The magnetic elements 861 and 862 are two magnets, which are telescoped onto the shaft 221, are respectively coupled to two end portions of the bearing 23, and are arranged along the axial direction to form a magnetic loop C6. Herein, the poles of the magnetic elements are arranged oppositely. The magnetic fluid 863 and a lubricant 31 are mixed together and are kept between the sleeve 54 and the shaft 221. The magnetic fluid 863 contains iron, cobalt, nickel or alloys thereof. The lubricant 31 provides the lubrication between the bearing 23 and the shaft 221.

The magnetic fluid bearing structure and the magnetic loop formed thereby according to the invention provide three functions. First, the lubricant is uniformly distributed between the bearing and the shaft to provide the lubrication function according to the provision of the magnetic bearing structure. Second, the magnetic fluid is attracted by the magnetic effect between the magnetic element and the shaft to form the oil seal structure so that the lubricant can also be kept in the bearing after the motor has rotated for a long period of time and the lubricant consumption can be avoided. Third, the magnetic loop can generate the larger axial attracting force so that the shaft can rotate steadily, and cannot generate the additional vibration and noise due to up and down vibrations caused by the high-rotation speed of the motor. The three functions can significantly enhance the reliability and lifetime of the motor.

In summary, the motor having the magnetic fluid bearing structure according to the invention prevents the lubricant of the bearing from leaking according to the magnetic fluid accommodated between the bearing and the shaft and the magnetic effect between the magnetic element and the magnetic fluid. In addition, the generated hydraulic pressure provides the additional axial and radial supports to make the shaft rotate steadily relative to the bearing. Compared with the related art, the magnetic fluid of the invention generates the additional axial and radial supporting hydraulic pressures, which can provide the supporting forces when the shaft is either rotating or kept stationary, according to the magnetic field generated by the magnetic loop. In addition, the invention can enhance the rotating stability of the shaft, and can further keep the lubricant in the bearing effectively according to the magnetic attracting function of the magnetic element. Thus, the lubricant consumption can be decreased, and the reliability and the lifetime of the motor can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A motor comprising:
a rotor having a shaft;
a stator disposed corresponding to the rotor and having a sleeve;
a lubricant disposed in the sleeve; and
a magnetic fluid bearing structure accommodated in the sleeve and having a bearing, at least one magnetic element and a magnetic fluid;
wherein the bearing is telescoped onto the shaft, the magnetic element is disposed adjacent to the bearing, the magnetic fluid is kept between the bearing and the shaft, and the lubricant is free from leaking according to a magnetic effect between the magnetic fluid and the magnetic element.

2. The motor according to claim 1, wherein the magnetic element is a permanent magnet, magnetite, electronic magnet, or magnetic-pressure magnet.

3. The motor according to claim 1, further comprising magnetic force loop formed by the magnetic element and distributed axially or radially with respect to the shaft.

4. The motor according to claim 1, further comprising a chamber formed between the shaft and the bearing for accommodating the lubricant.

5. The motor according to claim 1, wherein N and S poles of the magnetic element are arranged axially or radially relative to the shaft.

6. The motor according to claim 1, wherein the magnetic fluid contains iron, cobalt, nickel or alloys thereof.

7. The motor according to claim 1, wherein the magnetic element is telescoped to the bearing, or disposed adjacent to an outer ring of the bearing and against the sleeve.

8. The motor according to claim 7, further comprising at least one first positioning element disposed against the shaft or adjacent to an end portion of the shaft, and the first positioning element is a ring, magnetic-pressure magnet or wear-resistant sheet.

9. The motor according to claim 7, further comprising a second positioning element disposed against the bearing.

10. The motor according to claim 1, wherein the magnetic element is disposed adjacent to an end portion of the bearing and mounted around the shaft.

11. The motor according to claim 10, wherein the sleeve is a hollow cylinder with a closed end or a hollow cylinder having an end closed by a cover.

12. The motor according to claim 10, wherein the magnetic element is a circular magnet having a plurality of N and S poles and magnetic-conducting regions arranged alternately to form a radial magnetic loops distribution for attracting the magnetic fluid.

13. The motor according to claim 10, further comprising at least a magnetic-conducting element combined with the magnetic element.

14. The motor according to claim 13, wherein the magnetic-conducting element is a claw-pole magnetic yoke, or magnetic yoke.

15. The motor according to claim 14, wherein the shaft has a magnetic-conducting property.

16. A motor comprising:
a rotor having a shaft;
a stator disposed corresponding to the rotor and having a sleeve;
a lubricant disposed in the sleeve; and
a magnetic oil seal structure telescoped onto the sleeve and having a bearing, a magnetic fluid, at least two magnetic elements;
wherein the magnetic fluid is kept between the sleeve and the shaft, and one of the two magnetic elements is disposed on an end portion of the sleeve.

17. The motor according to claim 16, wherein the two magnetic elements are disposed on the end portion of the sleeve and arranged repellently along an axial direction of the shaft.

18. The motor according to claim 17, wherein the shaft has at least one slot or projection adjacent to the two magnetic elements.

19. The motor according to claim 16, wherein the other magnetic element is disposed on the other end portion of the sleeve.

20. A motor comprising:
a rotor having a shaft having magnetic property;
a stator disposed corresponding to the rotor and having a sleeve;
a lubricant disposed in the sleeve; and
a magnetic oil seal structure accommodated in the sleeve for sealing an end portion of the sleeve and having a magnetic fluid, at least one magnetic element and at least one magnetic-conducting element;
wherein the magnetic fluid is kept between the sleeve and the shaft, the magnetic element is disposed adjacent to an end portion of the shaft, the magnetic-conducting element is disposed adjacent to an opening of the sleeve to close the opening thereof and a magnetic loop is formed by the shaft, the magnetic element and the magnetic-conducting element.
